(19) United States
(12) Patent Application Publication
(10) Pub. No.: US 2008/0127318 A1
(43) Pub. Date: May 29, 2008

(54) GEOGRAPHICALLY SENSITIVE IDENTIFICATION VERIFICATION AND NOTIFICATION SYSTEM FOR SOCIAL NETWORKING

(76) Inventor: Robert M. Adler, West Palm Beach, FL (US)

Correspondence Address: McHale & Slavin, P.A., 2855 PGA Boulevard, Palm Beach Gardens, FL, 33410, US

(21) Appl. No.: 11/557,599

(22) Filed: Nov. 8, 2006

(51) Int. Cl. H04L 9/32; G06F 15/16; G06F 17/30; G06F 7/04

(52) U.S. Cl. 726/7

(57) ABSTRACT

A method for verifying the identity of a subscriber seeking member access to a social network on the Internet. The method employs a central computer that is in communication with the Internet. A member database is configured on the central computer. The member database for receipt of predetermined data sets that solicit information for use in member identification. Information received from a subscriber seeking access as a member is verified against a government operated identity database. If the subscriber identity is verified then the member is provided access to the social network. If the subscriber identity is not verified, then the subscriber is denied access to the social network and the central computer creates an advisory alert of the subscriber that failed. The advisory alert is transmitted through the Internet to members in the geographical area matching the geographic area of that the subscriber was unable to verify.

### RELATED APPLICATIONS

This application is related to U.S. Pat. Nos. 6,401,095; 6,505,203; 6,581,073 and U.S. patent applications Ser. No. 10/402,423 filed Mar. 28, 2003; Ser. No. 11/107,346 filed Apr. 15, 2005; Ser. No. 11/138,669 filed May 25, 2005, Ser. No. 11/373,517 filed Mar. 10, 2006; and Ser. No. 11/414,899 filed May 1, 2006, the contents of which are herein incorporated by reference.

### FIELD OF THE INVENTION

The invention relates to communication systems, and in particular to a system and method for registering and verifying internet subscribers, and broadcasting advisory alerts to a geographical area over a global computer network on a subscriber basis information on those failing verification.

### BACKGROUND OF THE INVENTION

The global computer network (“internet”) has essentially made the world a much smaller space. With minimal effort, an individual can communicate with another individual located next door, or around the world. Communication can be passive such as the use of websites, active such as the use of e-mail, or in real time such as the use of chat rooms. The affordability of such communication has created a service industry directed to the further simplification of networking. For instance, MySpace.com is a service that uses the Internet for online communication. Subscribers connect through an interactive network for sharing of member profiles, e-mail, web forums, weblogs, and the like. The result is a new age of social networking providing individuals a way of creating relationships with other individuals through various social familiarities ranging from casual acquaintances to close familial bonds.

Social networks enable individuals to socialize through computer mediated communication. Communication may be one on one, e.g. e-mail and instant messaging; one to many, e.g. web pages and blogs; many to many such as in wikis communication modes. The wikis being a type of website that allows a user to easily add, remove, or otherwise edit allowing for use as an effective tool for collaborative editing.

Common to the social networking concept utilized on the internet is the idea of community development in which membership is voluntary and reputations are earned by winning the trust of other members.

Explicit social networks have a search engine that allows individuals to find other individuals according to explicitly stated social relationships. Individuals may share their relationships on their own websites, thus forming a decentralized online social network.

Implicit social networks have a search engine that allows individuals to filter search results based upon classes of social networks they trust, such as shared high school activities, geographical location, and so forth.

The pervasiveness of the Internet is unique in technological history, but has also developed a much darker side. Most people, including children, have easy access to the Internet at home, work, school, and at play. This easy access appeals to the natural exploratory nature of children making it a target area for sexual predators. According to Dateline, as of January 2006 law enforcement officials estimate that as many as 50,000 sexual predators are on-line at any given moment. This number has been cited by the Attorney General Alberto Gonzales and clearly indicates that many individuals, in particular children, have a great opportunity of being approached.

The current on-line social networks allow individuals to use code names which are designed to give the individual a level of anonymity. This anonymity has cascaded into a shield used by sexual predators to convince children that they are of the same age, social interests, or otherwise use false information in an effort to penetrate both explicit and implicit social networking systems. If the predator is able to reach a child, they can use superior negotiating tools to convince the child to converse with them wherein, over a period of time, a level of trust is achieved and the sexual predator is then able to convince the child to meet in person. If the sexual predator is not successful, they can easily move on to another individual. So as to increase their odds of success, a sexual predator may use the repetitive features of a computer to contact hundreds of children a day.

### DESCRIPTION OF THE PRIOR ART

U.S. Pat. No. 5,878,116 is drawn to a method for locating a lost pet, person or object. The method describes the use of an identification number contained on a card held by the owner or on a tag attached to an item.

U.S. Pat. No. 5,036,610 describes a system for identifying a lost pet and locating its owner by use of a pet tag or collar having a telephone number and unique code number imprinted thereon. Information about the pet owner, stored in a database at a clearing house under a unique number, is available to the person who found the pet in response to a phone call to the clearing house. This system lacks the ability to alert public or private institutions or individuals regarding the pet's disappearance. It also does not take into account any information which would enable the selection of a geographic area having a high probability of containing the pet.

U.S. Pat. Nos. 6,401,095; 6,505,203; and 6,581,073, issued to the present inventor, are directed to systems which use an algorithm to send geographically targeted e-mail or notices of an advisory event. These patents are directed to systems which utilize the Internet as an access point to provide information pertaining to missing persons, pet loss notification, or advisory alerts. The systems canvass specific geographic areas in a matter of seconds to aid in the location of a missing person or pet.

Patents related to on-line social networking are known in the art including U.S. Pat. No. 7,069,308; Several online “matching” sites for dating and friend-making currently operate on the Internet (Match.com, Matchmaker.com, etc.), and several patents have been granted for online matching systems (Sudai, et al. U.S. Pat. No. 5,950,200; Collins U.S. Pat. No. 5,963,951; Sutcliffe, et al. U.S. Pat. No. 6,052,122; Collins U.S. Pat. No. 6,061,681; Sutcliffe, et al. U.S. Pat. No. 6,073,105; Sutcliffe, et al. U.S. Pat. No. 6,073,105). Other online services offer forums for communication between communities of users. These services include message boards, email lists, chat rooms, personal home pages, and web logs (see, for examples, US patents: Teibel U.S. Pat. No. 6,366,962; and Teibel et al. U.S. Pat. No. 6,363,427). Such services exist for both one-to-many and many-to-many communication. These services provide a forum where profiles or messages are viewed by a specific individual, the general public, or the entire membership of a specific defined group. Several patents and patent applications (although apparently no inventions in actual use) appear to recognize the value of social networks, and contemplate online systems to exploit them (de l'Etraz et al. U.S. Pat. No. 6,073,138; de l'Etraz et al. U.S. Pat. No. 6,324,541; Tomabene 20020023132; and Work 20020059201). These systems generally rely on a company's or an individual's computerized address book, and suggest merging multiple address books to create a social networking tool. U.S. Pat. No. 5,950,200 Sudai is for a Method and apparatus for detection of reciprocal interests or feelings and subsequent notification. U.S. Pat. No. 5,963,951 is for Computerized on-line dating service for searching and matching people. U.S. Pat. No. 5,978,768 is for a Computerized job search system and method for posting and searching job openings via a computer network. U.S. Pat. No. 6,052,122 is for a Method and apparatus for matching registered profiles. U.S. Pat. No. 6,061,681 is for On-line dating service for locating and matching people based on user-selected search criteria. U.S. Pat. No. 6,073,138 is for a method and computer program product for providing relational patterns between entities. U.S. Pat. No. 6,175,831 is for a method and apparatus for constructing a networking database and system. U.S. Pat. No. 6,249,282 is for a Method and apparatus for matching registered profiles. U.S. Pat. No. 6,324,541 is for a method, and computer program product for providing relational patterns between entities. U.S. Pat. No. 6,366,962 is for a method and apparatus for a buddy list. U.S. Pat. No. 6,735,568 is for a method and system for identifying people who are likely to have a successful relationship. U.S.2004/0148275 is a pending application for employing social networks for information discovery.

Thus, the prior art suffers from the inability to distribute an alert, utilizing a medium which can rapidly reach a majority of the targeted audience, regarding a possible sexual predator that is attempting to breach the verification process for a social membership in a timely fashion and to an appropriate geographical area.

Thus, what is lacking in the art is a method of registering members for a social network, verifying the identification of the member, and providing notification to other members in a geographically sensitive area that an attempted breach of identification has been attempted.

### SUMMARY OF THE INVENTION

Disclosed is a method for verifying the identity of a subscriber seeking member access to a social network on the Internet. The method employs a central computer that is in communication with the Internet. A member database is configured on the central computer, the member database for receipt of predetermined data sets that solicit information for use in member identification. Database information includes at least one piece of identification that is geographically specific and can be verified. For instance, a member may submit their state, district or school identification which can be verified through the respective database. Information received from a subscriber seeking access as a member is verified against the government operated identity database. If the subscriber identity is verified then the member is provided access to the social network. If the subscriber identity is not verified, then the subscriber is denied access to the social network and the central computer creates an advisory alert of the subscriber that failed. The advisory alert is transmitted through the Internet to members in the geographical area matching the geographic area of that the subscriber was unable to verify.

Accordingly, it is an objective of the instant invention to provide a subscriber-based verification system for individuals using a social network on the internet.

It is a further objective of the instant invention to provide a subscriber-based advisory alert broadcast system to members of a social network to notify those in a geographic location surrounding a member who was approached by an individual using unverified information.

It is another objective of the instant invention to provide a subscriber-based advisory alert broadcast system which associates a geographical area with a given alert utilizing an algorithm.

An objective of this invention is to provide a social network for children where child predators are locked out through data base correlation and verification.

Another objective fo this invention is to provide a front-line-of-defense security for children networking on the Internet without the guidance of a parent or educator.

Still another objective is to provide a software program that can verify the end user by interacting with a district's or state's student data base.

Yet still another objective is to provide a software program that will recognize and verify an end user's log in as a bone fide student at his/her respective school. The program having the ability to match student name, school of attendance, and student identifier with that listed with the state.

Another objective is to provide a software program that will provide verification of home schooled children and private/religious schools.

Other objectives and advantages of this invention will become apparent from the following description taken in conjunction with examples, and certain embodiments of this invention.

### DETAILED DESCRIPTION OF THE INVENTION

While the present invention is susceptible of embodiment in various forms, hereinafter is described a presently preferred embodiment with the understanding that the disclosure is to be considered an exemplification of the invention and is not intended to limit the invention to the specific embodiments described.

The present invention provides a method of registering members to a social network, verifying the member identification, and notifying others when an unauthorized attempt is made to access the social network.

A central notification computer is in communication with a database of subscribers whose identity has been verified. The central notification computer is shown as a single device for ease of description, however, the central notification computer can be a plurality of computers in a hierarchal arrangement.

An advisory alert is triggered by an event, such the attempt by a predator to contact a child wherein a notification is initiated at the central notification computer to a geographic area having a defined perimeter associated with the advisory alert. This area would be the general location which may be affected by the event or most likely to contain the areas that the child that was solicited may traverse. An algorithm is employed at the central notification computer to retrieve the addresses of the local members associated with the locations within the defined perimeter. The advisory alert is then transmitted in the preferred manner requested by the member, whether it be text messaging, e-mail, video and audio formats to the subscriber addresses. Based upon the information provided by the unverified user of the system, the advisory alert can be adjusted to target the area most propable that the unverified user was attempting to access. For instance, if the unverified user was targeting 3^{rd} grade children, then the advisory alert may be targeted to the parents and teachers of the 3^{rd} grade students in the area solicited.

By way of example, if a subscriber is attempting to access the social network by claiming he is a student of Palm Beach Gardens High School, and the subscriber information can not be verified, the subscriber is denied access to the Social Network as a member. Further, the advisory alert is sent to all members in the geographical area of Palm Beach Gardens High School that an attempt to access the social network was made and failed, alerting those members that any contact by the failed subscriber should be notified to the authorities. The advisory alert may also be sent to the local authorities as well as the parents should the members in that geographical area be minors.

In another aspect of the invention, advisory alerts are disseminated based on information received from conventional sources, such as government based Emergency Alerting System (EAS) broadcasts, commercial news organizations, wire services, law enforcement agencies, etc. to any of the members that could be affected in the geographical area. The advisory alerts are geographically specific and are sent only to subscribers in the relevant geographic areas or neighborhoods.

In one embodiment, the database server may rely on two SUN ENTERPRISE 450 servers or equivalents configures to operate as a cluster. ORACLE SERVER EE 8i, coupled with ORACLE PARALLEL SERVER or equivalents will optimize the SUN cluster architecture to provide an optimum database system. Data processing may be handled by ORACLE APPLICATION SERVER ENTERPRISE and ORACLE INTERMEDIA or equivalents. The messaging system may be based upon a cluster architecture also and may utilize at least two SUN ENTERPRISE 2 Model 1400 servers to support SUN's SENDMAIL messaging server. Using the same physical architecture as the messaging system, the web server may implement NETSCAPE ENTERPRISE SERVER.

The network/telecom may utilize a device having the capabilities of a CISCO 7500 Series router, particularly preferred is a CISCO 7576. Desirable characteristics are LAN/WAN service support, redundancy, reliability and performance. Scalability is accomplished due to a bandwidth extensible to 4 Gbps. Switching is accomplished via a 3COM SUPERSTACK II Switch 3300 or equivalent.

In the preferred embodiment, the primary focus is on preventing a predator from gaining access to the social networking database. By way of example, Mike Jones is a high school student at a school in north Nashville. Mike is interested in socializing with others in his area so he logs onto a social networking website, in this case RU4REAL™.com. To enter the RU4REAL™ website, Mike must enter three pieces of verifiable information such as his name, school, and district issued I.D. number. This information is matched and verified through a “firewall within a firewall” by coordination with the school district or state database. Alternatively, Mike may visit a participating vendor, such as a Target Store where the information can be verified in person. Upon verification, Mike is granted a password and access to the website. When a predator attempts to log in to communicate with a child, even if the predator knows the child's name and the name of his school, the predator can only log in after providing similar verification data. Since a predator could not obtain similar verification, but could figure out how to subscribe to the RU4REAL™ website, he would attempt to enter false identification data but would be denied access due to lack of verification. The attempt at using false identification is acknowledged by first notifying the predator of the unauthorized attempt to help discourage any further attempts. In addition, an advisory notice is sent to all members in a predefined geographically area around the predator claimed to be located, as well as the areas that he attempted to infiltrate, that an attempt was made to breach the verification program.

It should be noted that each State has different identification techniques to secure their school aged children. For instance, Tennessee uses different I.D. numbers from district numbers. They refer to these as “student verifiers”. Tennessee school children do not know their state verifiers. Thus, in Tennessee if the state database is employed for match verification, the state number will have to match the district's number.

Verification techniques can be customized for particular states, school districts, even schools. For instance, most schools today do not publish student directories because of today's safety and privacy concerns. However, in Tennessee, schools are allowed to print directories if they notify parents in advance. Parents, subsequently, are allowed to opt in as to any information supplied about their child (children). The result is the use of Directories is sporadic, incomplete, and limited in coverage.

Student Identification Numbers: Students in school districts are assigned an I.D. number that becomes an identifier in their school's and district's data base. This identifier stays with the student throughout the life of his/her years in that district. If he/she transfers to another district, he/she is issued another identifier unique to that district. The State of Tennessee has a different identifier for each student that remains constant with the student throughout his/her 13 years of public education in the state. This type of identification is currently in use in most states. Students, however, know their school I.D. numbers but not their state I.D. numbers. Therefore, it is recommended that verification is performed by matching district verifiers with state verifiers when state data bases as the source of verification. Alternatively, the matching of district verifiers with some other identifier provided by the student listed at the time of registration, which may include using district databases.

Data Bases: State departments of education have student data bases as well as the individual districts in their state. Student achievement on state mandated testing, along with credits and grades, are noted at the state level. Under the Family Educational Rights and Privacy Act (FERPA), as well as under state and district guidelines, schools cannot release student names and I.D. numbers to the public.

The instant invention allows for verifying the identity of a subscriber seeking member access to a social network on a global computer network, and broadcasting a geographically sensitive advisory alerts of a subscriber's failed attempt to secure access as a member to said social network. The method follows the steps of providing a central notification computer in communication with the global computer network. Creating a member database for coupling to the central notification computer. The member database having a plurality of predetermined data sets for inquiry of information for use in member identification wherein at least one of the data sets requires a geographic location. Receiving information from a subscriber seeking access as a member to the social network, the information obtained in accordance with the data sets. Verification of the data sets against a government operated identity database. The verified data sets providing access to the social network by the member. Creating an advisory alert when a subscriber seeking access to the social network is not verified. And transmitting the advisory alert through the global computer network to members in the geographical area matching the geographic area of the subscriber that is not verified. The advisory alert may also be transmitted to the authorities in the geographical area and can be transmitted back to the author of the failed attempt to act as a further determent. The advisory can be sent to a perimeter around the child that the subscriber attempted to contact, such as a five mile area. The advisory may be sent to all members of school of the child that the subscriber attempted to contact.

The algorithm can be modified to adjust the perimeter of the advisory in accordance with the amount of contact initiated by the predator. For instance, if a series of contacts have be logged by the predator targeting a particular age group of children, sports activity, school, or the like wherein the algorithm directs the advisory alert to the demographic that is most likely to be targeted.

It is to be understood that while a certain form of the invention is describecd, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method for verifying the identity of a subscriber seeking member access to a social network on a global computer network, and broadcasting a geographically sensitive advisory alerts of a subscriber's failed attempt to secure access as a member to said social network comprising: providing a central notification computer in communication with the global computer network; creating a member database for coupling to said central notification computer, said member database having a plurality of predetermined data sets for inquiry of information for use in member identification, at least one of said data sets requiring a geographic location; receiving information from a subscriber seeking access as a member to said social network, said information obtained in accordance with said data sets; verification of said data sets against a government operated identity database, verified data sets providing access to said social network as a member; creating an advisory alert when a subscriber seeking access to said social network is not verified; and transmitting said advisory alert through said global computer network to members in a predefined geographical area.

2. The method for verifying the identity of a subscriber seeking member access to a social network according to claim 1 including the step of transmitting said advisory alert to authorities in said geographical area.

3. The method for verifying the identity of a subscriber seeking member access to a social network according to claim 1 including the step of transmitting said advisory alert to the subscriber seeking access to said social network.

4. The method for verifying the identity of a subscriber seeking member access to a social network according to claim 1 wherein said geographic area is defined as school of the child that the subscriber attempted to contact.

5. The method for verifying the identity of a subscriber seeking member access to a social network according to claim 1 wherein said geographic area is defined as a perimeter around the child that the subscriber attempted to contact.

6. The method for verifying the identity of a subscriber seeking member access to a social network according to claim 1 wherein said geographic area is defined as a perimeter around the area of the unverified subscriber.

7. The method for verifying the identity of a subscriber seeking member access to a social network according to claim 1 including a means for targeting a demographic group within said geographical area.

8. The method for verifying the identity of a subscriber seeking member access to a social network according to claim 1 wherein said information is presented by a member at a participating vendor location.
